(19) United States
(12) Patent Application Publication
(10) Pub. No.: US 2025/0174097 A1
(43) Pub. Date: May 29, 2025

(54) DATA INPUT APPARATUS PROVIDING THEFT-MONITORING FUNCTION FOR A PORTABLE PC

(71) Applicant: CS Co., Ltd., Jeju-si (KR)

(72) Inventor: Minho CHOI, Jeju-si (KR)

(21) Appl. No.: 18/520,079

(22) Filed: Nov. 27, 2023

(51) Int. Cl. G08B 13/14

(52) U.S. Cl. CPC G08B 13/1436

(57) ABSTRACT

A data input apparatus for providing a theft-monitoring function for a portable PC is provided, in which the data input apparatus is a data input apparatus which is used to assist a data input function of a portable PC, and which includes a main body part that generates input data for the portable PC, and an access part connected to the main body part in a wired manner and accessed to an external communication port of the portable PC, in which the access part includes a coordinate detection sensor and a USB hub controller, and the USB hub controller analyzes a signal from the coordinate detection sensor and transmits an alarm sound emission signal to the portable PC when determining that a movement occurs in the portable PC.

### TECHNICAL FIELD

The present disclosure relates to a data input apparatus for providing a theft-monitoring function for a portable PC, and more specifically, to a data input apparatus that recognizes the situation when a portable PC theft occurs and sends out an alarm sound to protect the portable PC from a theft suspect.

### BACKGROUND

In recent years, the use of portable PCs such as laptop PCs, tablet PCs, etc. has increased. Accordingly, cases of portable PCs being stolen in multi-use spaces such as cafeterias, libraries, etc. have also increased. In Denmark, it has been reported that approximately 4,000 cases of laptop PC theft occur annually.

Portable PC theft cases mainly occur when the owner leaves the portable PC on a table or desk in a multi-use space and is temporarily away. When a third party accesses the portable PC for the purpose of theft while the owner is away, people other than the owner cannot know whether the third party has the purpose of theft, so it is easy for the portable PC to be stolen.

As a representative example of the related technology for preventing the theft of portable PCs, anti-theft software that is installed and used on portable PCs has been developed. To use it, anti-theft software must be running on the portable PC and the software must be placed in surveillance mode before the owner leaves the computer.

However, if a third party with the intention of stealing the portable PC turns off the portable PC or terminates the execution of the software, the software will not work, and it will be virtually impossible to prevent theft.

### SUMMARY

The present disclosure has been derived to solve the problems of the related art described above, and an object of the present disclosure is to provide a data input apparatus for providing a theft-monitoring function for a portable PC, which does not require dedicated software for theft monitoring and which does not allow third parties to recognize the theft monitoring status.

Accordingly, a data input apparatus is provided, which may be used to assist data input function of a portable PC and include a main body part that generates input data for the portable PC, and a access part connected to the main body part in a wired manner and accessed to an external communication port of the portable PC, in which the access part may include a coordinate detection sensor and a USB hub controller, and the USB hub controller may analyze a signal from the coordinate detection sensor and transmit an alarm sound emission signal to the portable PC when determining that a movement is occurred in the portable PC.

According to an embodiment, the USB hub controller may include a first reception channel for receiving data from the coordinate detection sensor and a second reception channel for receiving data from the main body part.

In addition, a data input apparatus is provided, which may be used to assist a data input function of a portable PC and include a main body part that generates input data for the portable PC, and a access part connected to the main body part in a wired manner and accessed to an external communication port of the portable PC, in which the access part may include a coordinate detection sensor, the main body part may include a main circuit and a USB hub controller, and the USB hub controller may analyze a signal from the coordinate detection sensor and transmit an alarm sound emission signal to the portable PC when determining that a movement is occurred in the portable PC.

According to an embodiment, the USB hub controller may include a first reception channel for receiving data from the coordinate detection sensor and a second reception channel for receiving data from the main circuit.

In addition, a data input apparatus used to assist a data input function of a portable PC is provided, which may include a main body part that generates input data for the portable PC, and a access part connected to the main body part in a wireless manner and accessed to an external communication port of the portable PC, in which the access part may include a wireless receiver, a coordinate detection sensor, and a USB hub controller, and the USB hub controller may analyze a signal from the coordinate detection sensor and transmit an alarm sound emission signal to the portable PC when determining that a movement is occurred in the portable PC.

According to an embodiment, the USB hub controller may include a first reception channel for receiving data from the coordinate detection sensor and a second reception channel for receiving data from the main body part.

In addition, a data input apparatus used to assist a data input function of a portable PC is provided, which may include a main body part that generates input data for the portable PC, and a access part connected to the main body part in a wireless manner and accessed to an external communication port of the portable PC, in which the access part may include a wireless receiver and a coordinate detection sensor, and the wireless receiver may analyze a signal from the coordinate detection sensor and transmit an alarm sound emission signal to the portable PC when determining that a movement is occurred in the portable PC.

According to an embodiment, the wireless receiver may include a first reception channel for receiving data from the coordinate detection sensor and a second reception channel for receiving data from the main body part.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram showing a configuration of a data input apparatus according to a first embodiment of the present disclosure;

FIGS. 2 and 3 are diagrams showing applications of the data input apparatus according to the first embodiment;

FIG. 4 is a block diagram showing a configuration of a data input apparatus according to a second embodiment of the present disclosure;

FIG. 5 is a block diagram showing a configuration of a data input apparatus according to a third embodiment of the present disclosure;

FIGS. 6 and 7 are diagrams showing applications of the data input apparatus according to the third embodiment; and

FIG. 8 is a block diagram showing a configuration of a data input apparatus according to a fourth embodiment of the present disclosure.

### DETAILED DESCRIPTION

Hereinafter, embodiments of the present disclosure will be described in detail with reference to the drawings.

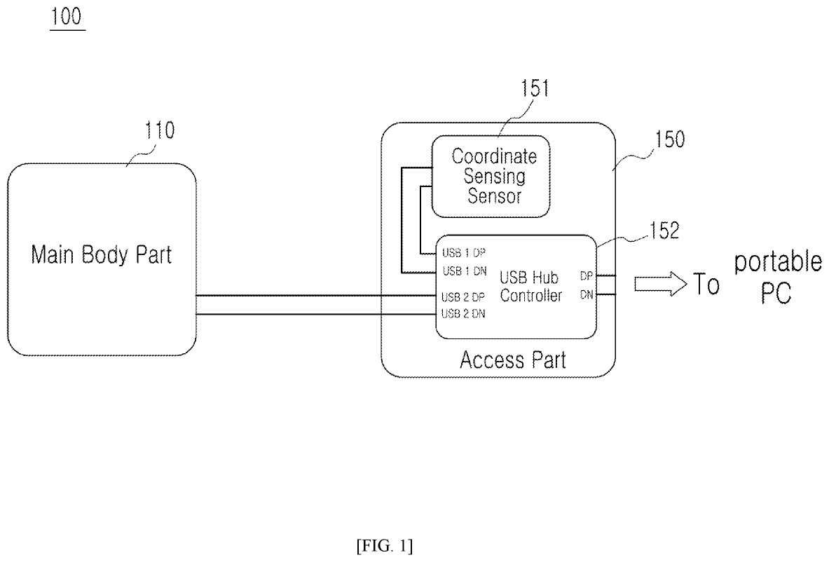

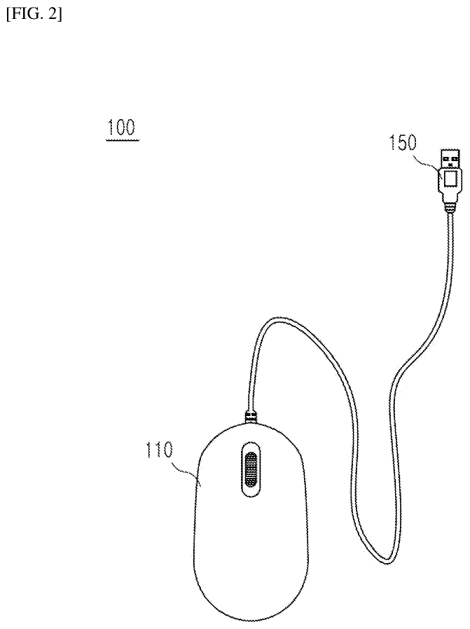

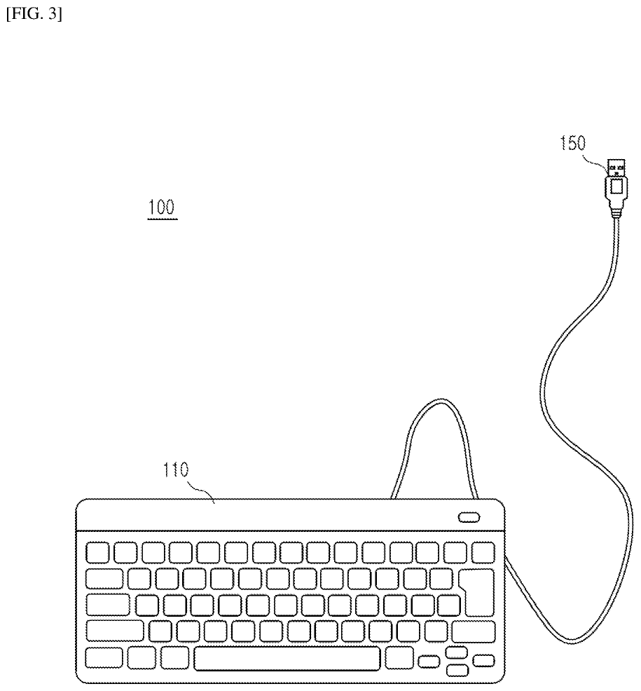

FIG. 1 is a block diagram showing a configuration of a data input apparatus according to a first embodiment of the present disclosure, and FIGS. 2 and 3 are diagrams showing applications of the data input apparatus according to the first embodiment.

A data input apparatus 100 is an auxiliary apparatus used to assist a data input function of a portable PC.

Representative examples of the portable PCs include laptop PCs and tablet PCs. However, aspects are not limited to the above, and the present disclosure can be equally applied to other types of portable PCs that can be carried around by the users for use.

Referring to FIG. 1, the data input apparatus 100 includes a main body part 110 and a access part 150.

The main body part 110 is a part that generates input data for the portable PC.

The access part 150 is a part accessed to an external communication port of the portable PC. The access part 150 is connected to the main body part 110 in a wired manner. The access part 150 receives the data generated from the main body part 110 and transmits the received data to the portable PC.

As illustrated in FIG. 2, the data input apparatus 100 may be implemented as a wired mouse. The main body part 110 is implemented as a mouse main body, and the access part 150 is implemented as a USB terminal connected to the main body part 110 with a cable.

As illustrated in FIG. 3, the data input apparatus 100 may be implemented as a wired keyboard. The main body part 110 is implemented as a keyboard body, and the access part 150 is implemented as a USB terminal connected to the main body part 110 with a cable.

The data input apparatus 100 of the first embodiment is not limited to the wired mouse or keyboard, and may be implemented with other types of apparatuses including a main body part that generates input data and a access part connected thereto by wire.

Referring again to FIG. 1, the access part 150 includes a coordinate detection sensor 151 and a USB hub controller 152.

The coordinate detection sensor 151 is a sensor for detecting the movement of the portable PC. As an example, the coordinate detection sensor 151 may be provided as a gyro sensor.

The USB hub controller 152 is connected by wire to the main body part 110 and the coordinate detection sensor 151, respectively.

The USB hub controller 152 includes two reception channels and one transmission channel. The channel marked “USB 1 DP/USB 1 DN” is the first reception channel, the channel marked “USB 2 DP/USB 2 DN” is the second reception channel, and the channel marked “DP/DN” is the transmission channel.

The USB hub controller 152 receives data from the coordinate detection sensor 151 through the first reception channel and receives data from the main body part 110 through the second reception channel. In addition, the USB hub controller 152 transmits data to the portable PC through the transmission channel.

When the portable PC is subjected to vibration or shock, or is moved by someone, the position of the portable PC changes, and the position change is detected by the coordinate detection sensor 151 embedded in the access part 150.

The signal detected by the coordinate detection sensor 151 is transmitted to the USB hub controller 152 through the first reception channel, and the USB hub controller 152 analyzes the signal transmitted from the coordinate detection sensor 151 to determine whether the position of the portable PC is changed.

If it is determined that the position of the portable PC is changed, the USB hub controller 152 sends an alarm sound emission signal to the portable PC, and upon receiving this signal, the portable PC emits a loud alarm sound.

Therefore, if a third party with the intention to steal the portable PC touches or moves the portable PC while the owner who has been using the portable PC is away from the computer, a loud alarm sound is immediately emitted from the portable PC, thereby preventing theft of the portable PC.

If the theft suspect is able to separate the access part 150 from the portable PC, then the alarm sound emission function will not operate. However, since the access part 150 of the present disclosure is implemented as a USB terminal attached to the input device such as the wired mouse or keyboard, the access part 150 has no difference in appearance from a normal USB terminal. Therefore, since the access part 150 of the present disclosure has the same appearance as the ordinary USB terminal, it is difficult for the theft suspect to think of separating the access part 150 from the portable PC to block the transmission of the alarm sound. As described above, the access part 150 of the present disclosure has a built-in coordinate detection sensor 151 for theft monitoring, but it is difficult for the theft suspect to notice its presence. In a sense, the coordinate detection sensor 151 embedded secretly into the access part 150 having the appearance of a normal USB terminal can be seen as a configuration that acts like a spy.

As described above, the USB hub controller 152 is provided with the two reception channels and accordingly receives the data from the coordinate detection sensor 151 through the first reception channel and receives data from the main body part 110 through the second reception channel.

As described above, since the data of the coordinate detection sensor 151 and the data of the main body part 110 are each transmitted to the USB hub controller 152 through separate channels, “data jam” phenomenon, that is the collision of two data does not occur during the data transmission.

If the data of the coordinate detection sensor 151 and the data of the main body part 110 are transmitted to the USB hub controller 152 through one common channel, transmission of one of the two data will be blocked because the two data cannot be transmitted to the USB hub controller 152 at the same time. Therefore, data from the coordinate detection sensor 151 may not be transmitted to the USB hub controller 152 due to interference with the data of the main body part 110. In this case, the coordinate detection sensor 151 for theft monitoring cannot function normally.

On the other hand, the present disclosure prevents a situation in which the function of the coordinate detection sensor 151 is interrupted due to data collision, because according to the present disclosure, the reception channel for the coordinate detection sensor 151 is separately allocated in the USB hub controller 152.

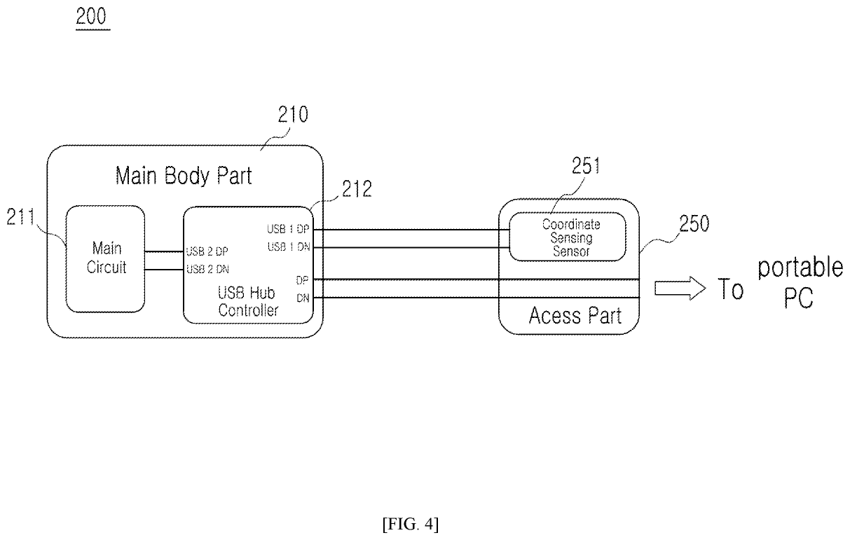

FIG. 4 is a block diagram showing a configuration of a data input apparatus according to a second embodiment of the present disclosure.

Like the data input apparatus 100 of the first embodiment, the data input apparatus 200 of the second embodiment also includes a main body part 210 and a access part 250, and may be implemented as an input device such as a wired mouse, keyboard, etc.

When the data input apparatus 200 is a wired mouse, the main body part 210 may be implemented as the mouse main body, and the access part 250 may be implemented as a USB terminal connected to the mouse main body with a cable. When the data input apparatus 200 is a wired keyboard, the main body part 210 may be implemented as the keyboard main body, and the access part 250 may be implemented as a USB terminal connected to the keyboard main body with a cable.

In the second embodiment, the main body part 210 includes a main circuit 211 and a USB hub controller 212, and the access part 250 includes a coordinate detection sensor 251. The main circuit 211 is an electronic circuit related to the basic function of the main body part 210, that is, the function of generating input data.

The second embodiment differs from the first embodiment in that the USB hub controller 212 is provided in the main body part 210.

However, in terms of functionality, the USB hub controller 212 according to the second embodiment is almost the same as the USB hub controller 152 according to the first embodiment. This will be described below.

The USB hub controller 212 includes a first reception channel marked “USB 1 DP/USB 1 DN”, a second reception channel marked “USB 2 DP/USB 2 DN”, and a transmission channel marked “DP/DN”. The USB hub controller 212 receives data from the coordinate detection sensor 251 through the first reception channel, receives data from the main circuit 211 through the second reception channel, and transmits data to the portable PC through the transmission channel.

The USB hub controller 212 analyzes the signal transmitted from the coordinate detection sensor 251, and if determining as a result of the analysis a change in the position of the portable PC, the USB hub controller 212 transmits an alarm sound emission signal to the portable PC, and upon receiving this signal, the portable PC emits a loud alarm sound.

Again, in the data input apparatus 200 of the second embodiment, the reception channel for the coordinate detection sensor 251 is separately allocated in the USB hub controller 212, so that a situation in which the coordinate detection sensor 251 cannot function properly due to data collision does not occur.

Meanwhile, unlike the first embodiment in which both the coordinate detection sensor 151 and the USB hub controller 152 are provided in the access part 150, in the second embodiment, only the coordinate detection sensor 251 is provided in the access part 250. Therefore, in the case of the second embodiment, it is possible to design more compact-sized access part 250.

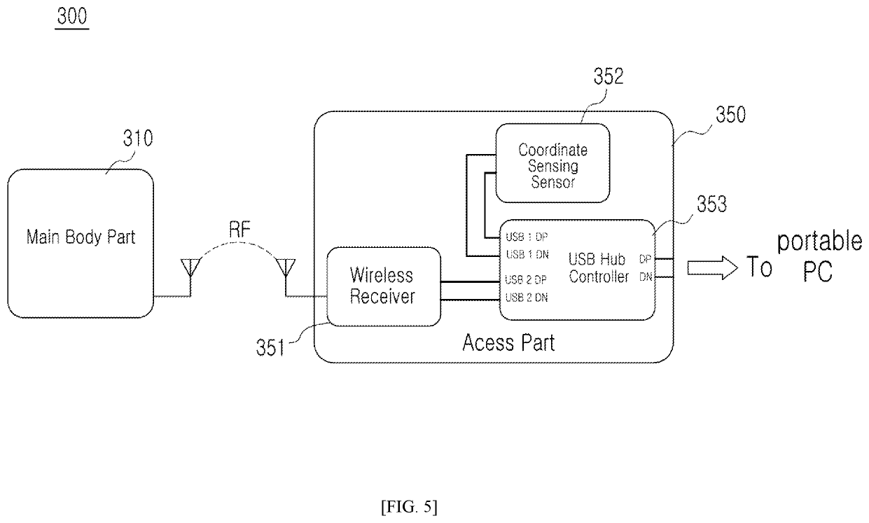

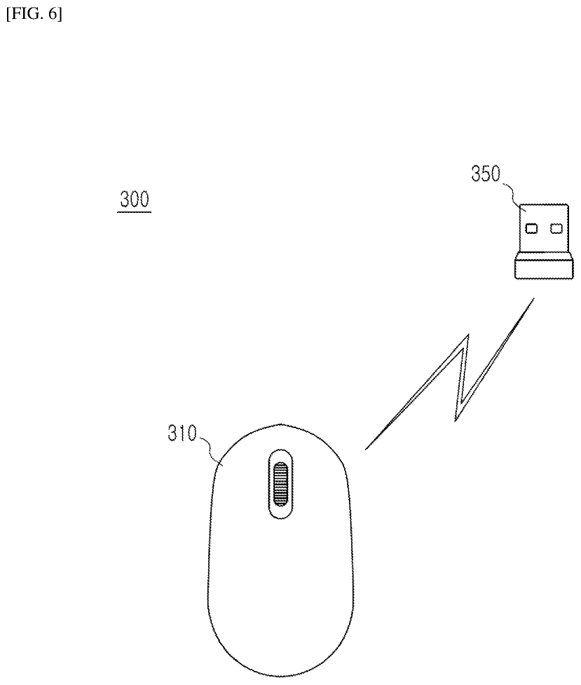

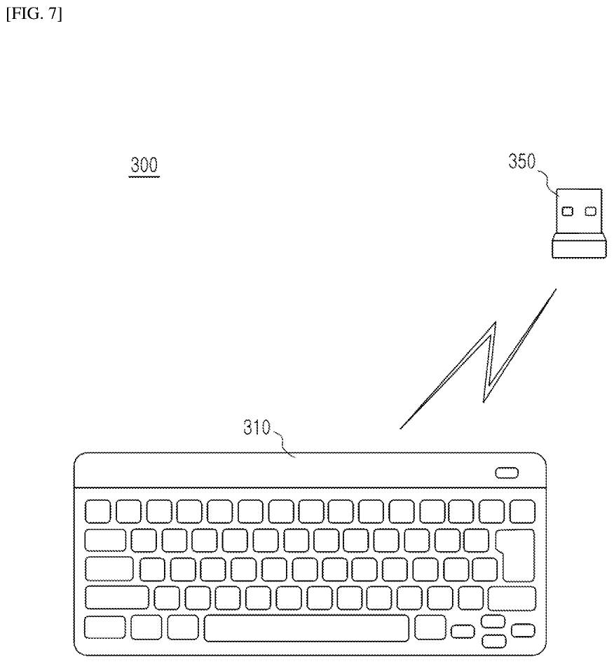

FIG. 5 is a block diagram showing a configuration of a data input apparatus according to a third embodiment of the present disclosure, and FIGS. 6 and 7 are diagrams showing applications of the data input apparatus according to the third embodiment.

A data input apparatus 300 is an auxiliary apparatus used to assist a data input function of a portable PC.

Representative examples of the portable PCs include laptop PCs and tablet PCs. However, aspects are not limited to the above, and the present disclosure may be applied equally to other types of portable PCs.

Referring to FIG. 5, the data input apparatus 300 includes a main body part 310 and a access part 350.

The main body part 310 is a part that generates input data for the portable PC.

The access part 350 is a part accessed to an external communication port of the portable PC. The access part 350 is connected to the main body part 310 wirelessly. The access part 350 receives the data generated from the main body part 310 and transmits the received data to the portable PC.

As illustrated in FIG. 6, the data input apparatus 300 may be implemented with a wireless mouse corresponding to the main body part 310 and a USB dongle corresponding to the access part 350. Alternatively, as illustrated in FIG. 7, the data input apparatus 300 may be implemented with a wireless keyboard corresponding to the main body part 310 and a USB dongle corresponding to the access part 350.

Referring again to FIG. 5, the access part 350 includes a wireless receiver 351, a coordinate detection sensor 352, and a USB hub controller 353.

The wireless receiver 351 receives the input data generated from the main body part 310 through wireless communication and transmits the received data to the USB hub controller 353.

The coordinate detection sensor 352 is a sensor for detecting the movement of the portable PC. As an example, the coordinate detection sensor 352 may be provided as a gyro sensor.

The USB hub controller 353 is connected by wire to the wireless receiver 351 and the coordinate detection sensor 352, respectively.

The USB hub controller 353 includes two reception channels and one transmission channel. The channel marked “USB 1 DP/USB 1 DN” is the first reception channel, the channel marked “USB 2 DP/USB 2 DN” is the second reception channel, and the channel marked “DP/DN” is the transmission channel.

The USB hub controller 353 receives data from the coordinate detection sensor 352 through the first reception channel and receives data from the main body part 310 through the second reception channel. In addition, the USB hub controller 353 transmits data to the portable PC through the transmission channel.

The functions of the coordinate detection sensor 352 and the USB hub controller 353 are the same as those of the embodiments described above. That is, when a movement (a change in position) of the portable PC is detected by the coordinate detection sensor 352, the USB hub controller 353 transmits an alarm sound emission signal to the portable PC, and upon receiving the alarm sound emission signal, the portable PC emits an alarm sound to prevent theft.

The access part 350 of the present disclosure has the same appearance as that of a general USB dongle. Therefore, since the access part 350 of the present disclosure has the same appearance as the ordinary USB terminal, it is difficult for the theft suspect to think of separating the access part 350 from the portable PC to block the transmission of the alarm sound in advance. As described above, the access part 350 of the present disclosure has a built-in coordinate detection sensor 352 for theft monitoring, but it is difficult for the theft suspect to notice its presence. In a sense, the coordinate detection sensor 352 built secretly into the access part 350 having the appearance of a normal USB dongle can be seen as a configuration that acts like a spy.

As described above, the USB hub controller 353 is provided with the two reception channels and accordingly receives the data from the coordinate detection sensor 352 through the first reception channel and receives data from the main body part 310 through the second reception channel. As described above, the reception channel for the coordinate detection sensor 352 is separately allocated in the USB hub controller 353, so that a situation in which the coordinate detection sensor 352 cannot function properly due to data collision does not occur.

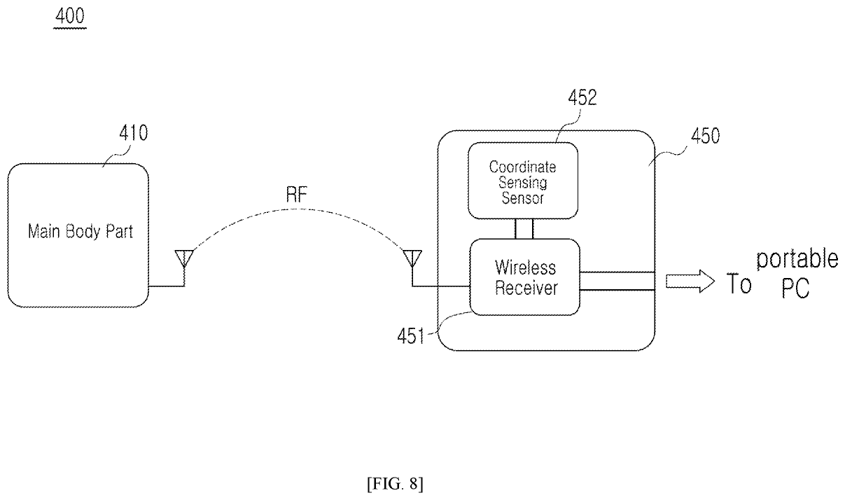

FIG. 8 is a block diagram showing a configuration of a data input apparatus according to a fourth embodiment of the present disclosure.

Like the data input apparatus 300 of the third embodiment, the data input apparatus 400 of the fourth embodiment also includes a main body part 410 and a access part 450. In addition, like the data input apparatus 300 of the third embodiment, the data input apparatus 400 of the fourth embodiment may also be implemented with a wireless mouse corresponding to the main body part 410 and a USB dongle corresponding to the access part 450. or implemented as a wireless keyboard corresponding to the main body part 410 and a USB dongle corresponding to the access part 450.

In the case of the fourth embodiment, the access part 450 includes a wireless receiver 451 and a coordinate detection sensor 452.

The wireless receiver 451 receives input data generated from the main body part 410 through wireless communication. In addition, the wireless receiver 451 also performs the function of the HSB Hub controller described above. That is, the wireless receiver 451 receives and analyzes data from the coordinate detection sensor 452, and, and transmits an alarm sound emission signal to the portable PC to prevent theft when determining that a movement is occurred in the portable PC.

In the case of the fourth embodiment, the access part 450 has a structure in which the wireless receiver 451 performs the functions of the HSB Hub controller in an integrated manner, and in this case, it is possible to manufacture a more compact-sized access part 450 compared to the access part 350 of the third embodiment.

The wireless receiver 451 is separately allocated a channel for receiving data from the coordinate detection sensor 452. Therefore, as in the case of the previous embodiments, a situation in which the coordinate detection sensor 452 does not function properly due to a data collision does not occur.

1. A data input apparatus used to assist a data input function of a portable PC, comprising:
a main body part that generates input data for the portable PC; and
an access part connected to the main body part in a wired manner and accessed to an external communication port of the portable PC,
wherein the access part includes a coordinate detection sensor and a USB hub controller, and
the USB hub controller analyzes a signal from the coordinate detection sensor and transmits an alarm sound emission signal to the portable PC when determining that a movement occurs in the portable PC.

2. The data input apparatus according to claim 1, wherein the USB hub controller includes a first reception channel for receiving data from the coordinate detection sensor and a second reception channel for receiving data from the main body part.

3. A data input apparatus used to assist a data input function of a portable PC, comprising:
a main body part that generates input data for the portable PC; and
an access part connected to the main body part in a wired manner and accessed to an external communication port of the portable PC,
wherein the access part includes a coordinate detection sensor, the main body part includes a main circuit and a USB hub controller,
and
the USB hub controller analyzes a signal from the coordinate detection sensor and transmits an alarm sound emission signal to the portable PC when determining that a movement is occurred in the portable PC.

4. The data input apparatus, according to claim 3, wherein the USB hub controller includes a first reception channel for receiving data from the coordinate detection sensor and a second reception channel for receiving data from the main circuit.

5. A data input apparatus used to assist a data input function of a portable PC, comprising:
a main body part that generates input data for the portable PC; and
an access part connected to the main body part in a wireless manner and accessed to an external communication port of the portable PC,
wherein the access part includes a wireless receiver, a coordinate detection sensor, and a USB hub controller, and
the USB hub controller analyzes a signal from the coordinate detection sensor and transmits an alarm sound emission signal to the portable PC when determining that a movement occurs in the portable PC.

6. The data input apparatus according to claim 5, wherein the USB hub controller includes a first reception channel for receiving data from the coordinate detection sensor and a second reception channel for receiving data from the main body part.
